(19) United States
(12) Patent Application Publication
(10) Pub. No.: US 2015/0278639 A1
(43) Pub. Date: Oct. 1, 2015

(54) AUTO MODE SELECTION IN FIBER OPTIC END-FACE IMAGES

(71) Applicant: AFL TELECOMMUNICATIONS LLC, Duncan, SC (US)

(72) Inventors: Michael Leighton, Deerfield, NH (US); Chris Theberge, Methuen, MA (US)

(73) Assignee: AFL TELECOMMUNICATIONS LLC, Duncan, SC (US)

(21) Appl. No.: 14/430,989

(22) PCT Filed: Jun. 19, 2014
(86) PCT No.: PCT/US14/43181

§ 371 Date: Mar. 25, 2015

Related U.S. Application Data
(60) Provisional application No. 61/836,946, filed on Jun. 19, 2013.

(51) Int. Cl. G06K 9/62; G06K 9/52; G06K 9/46; G01M 11/00

(52) U.S. Cl. CPC G06K 9/6267; G01M 11/30; G06K 9/52; G06K 9/46; G06K 9/6201; G06K 9/627; G06K 2009/4666

(57) ABSTRACT

A method of automatically determining a type of fiber in a fiber optic end-face image includes obtaining the fiber optic end-face image, searching the fiber optic end-face image to find a fiber core, selecting a region in the fiber optic end-face image comprising the fiber core, retrieving pixel intensity values of selected region, placing the retrieved pixel intensity values in an array, passing the array to a classifier, and determining a type of fiber based on a classification made by the classifier.

### CROSS-REFERENCE TO RELATED APPLICATIONS

This application is based upon and claims the benefit of priority from U.S. Provisional Application No. 61/836946, filed Jun. 19, 2013 in the United States Patent and Trademark Office, the disclosures of which are incorporated herein in its entirety by reference.

### BACKGROUND

1. Field

The invention is related to automatic detection of the type of fiber in a fiber optic cable, and more particularly to automatic selection of the type of fiber using fiber optic end face images.

2. Related Art

The background information provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Multi-mode and single-mode fiber optic cabling are the two most widely used fiber optic cable types in the telecommunication industry today. Scratches, defects, and other debris on the end-face of such fibers can cause network performance issues. The preferred way of determining fiber end-face cleanliness is to use automated pass/fail analysis. During pass/fail analysis of a fiber optic end-face, it is often required that the type of fiber undergoing the test—multimode or single mode—be known. Current automated end-face analysis tools either run analysis for both modes simultaneously or ask the user to input the type of fiber under test. Running analysis for both types simultaneously slows down the analysis process and can lead to mistakes when recording results. Asking the user to input the fiber type manually before analysis requires that the user knows the type of the fiber prior and can lead to mistakes if the incorrect type is selected. Accordingly, there is a need for automatic detection and/or selection of the type of fiber prior to performing the automated pass/fail analysis.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

According to an aspect of an exemplary embodiment, a method of automatically determining a type of fiber in a fiber optic end-face image includes obtaining a the fiber optic end-face image, searching the fiber optic end-face image to find a fiber core, selecting a region in the fiber optic end-face image comprising the fiber core, retrieving pixel intensity values of selected region, placing the retrieved pixel intensity values in an array, passing the array to a classifier, and determining a type of fiber based on a classification made by the classifier.

According to another exemplary embodiment, the classifier performs pattern matching on the array to classify the fiber core.

According to another exemplary embodiment, the classification made by the classifier is one of multi-mode fiber or single-mode fiber.

According to another exemplary embodiment, the determining the type of fiber includes one of determining that the fiber is a multi-mode fiber or determining that the fiber is a single-mode fiber.

According to another exemplary embodiment, the classifier uses at least one of a plurality of properties of the fiber optic end-face image to classify the fiber core.

According to another aspect of an exemplary embodiment, a method of classifying a fiber core includes receiving an array of pixel intensity values corresponding to a selected region of a fiber optic end-face image, performing pattern matching on the received array, and classifying the fiber core corresponding to the fiber optic end-face image based on the pattern matching.

According to another exemplary embodiment, the pattern matching includes comparing the pattern of the received array with the pattern of multi-mode fiber and single mode fiber.

According to another exemplary embodiment, the selected region comprises the fiber core.

According to another exemplary embodiment, the classifying the fiber core includes one of classifying the fiber core as a multi-mode fiber or classifying the fiber core as a single-mode fiber.

According to another aspect of an exemplary embodiment, a method of generating a classifier which classifies a fiber core using a fiber optic end-face image includes obtaining a plurality fiber optic end-face images, manually assigning a class to each of the plurality of fiber optic end-face images, applying a learning algorithm to the plurality of class assigned fiber optic end-face images, and generating a classifier based on the applied learning algorithm.

According to another exemplary embodiment, the learning algorithm is a supervised learning algorithm.

According to another exemplary embodiment, manually assigning a class includes one of manually assigning a multi-mode fiber class or manually assigning a single-mode fiber class.

According to an aspect of an exemplary embodiment, an apparatus for automatically determining a type of fiber in a fiber optic end-face image includes at least one memory operable to store program code, at least one processor operable to read the program code and operate as instructed by the program code, the program code including, obtaining code configured to cause the at least one processor to obtain a the fiber optic end-face image, searching code configured to cause the at least one processor to search the fiber optic end-face image to find a fiber core, selecting code configured to cause the at least one processor to select a region in the fiber optic end-face image comprising the fiber core, retrieving code configured to cause the at least one processor to retrieve pixel intensity values of selected region, placing code configured to cause the at least one processor to place the retrieved pixel intensity values in an array, passing code configured to cause the at least one processor to pass the array to a classifier, and determining code configured to cause the at least one processor to determine a type of fiber based on a classification made by the classifier.

According to another exemplary embodiment, the classifier performs pattern matching on the array to classify the fiber core.

According to another exemplary embodiment, the classification made by the classifier is one of multi-mode fiber or single-mode fiber.

According to another exemplary embodiment, the determining code is configured to cause the at least one processor to one of determine that the fiber is a multi-mode fiber or determine that the fiber is a single-mode fiber.

According to another exemplary embodiment, the classifier uses at least one of a plurality of properties of the fiber optic end-face image to classify the fiber core.

According to another aspect of an exemplary embodiment, a non-transitory computer readable recording medium stores a program used in an apparatus, including at least one processor, for automatically determining a type of fiber in a fiber optic end-face image, the program causes said at least one processor to obtain a the fiber optic end-face image, search the fiber optic end-face image to find a fiber core, select a region in the fiber optic end-face image comprising the fiber core, retrieve pixel intensity values of selected region, place the retrieve, pixel intensity values in an array, pass the array to a classifier, and determine a type of fiber based on a classification made by the classifier.

According to another exemplary embodiment, the classifier uses at least one of a plurality of properties of the fiber optic end-face image to classify the fiber core.

According to another exemplary embodiment, the program further causes said at least one processor to one of determine that the fiber is a multi-mode fiber or determine that the fiber is a single-mode fiber.

### BRIEF DESCRIPTION OF THE DRAWING

FIG. 1 illustrates an end-face image of a fiber optic cable providing a cross-sectional view of the fiber core, according to an exemplary embodiment.

FIG. 2 illustrates an end-face image of a fiber optic cable providing a cross-sectional view of the fiber core along with a selected region around the fiber core used by a classifier to classify the type of fiber, according to an exemplary embodiment.

FIG. 3 is a flowchart describing the generation of a classifier, according to an exemplary embodiment.

FIG. 4 is a flowchart describing the process of determining a fiber type, according to an exemplary embodiment.

FIG. 5 is a flowchart describing the functionality of a classifier in classifying the fiber core based on the end-face image of the fiber optic cable, according to an exemplary embodiment.

FIG. 6 illustrates a functional block diagram of an embodiment of an apparatus which determines the type of fiber in a fiber optic end-face image, according to an exemplary embodiment.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

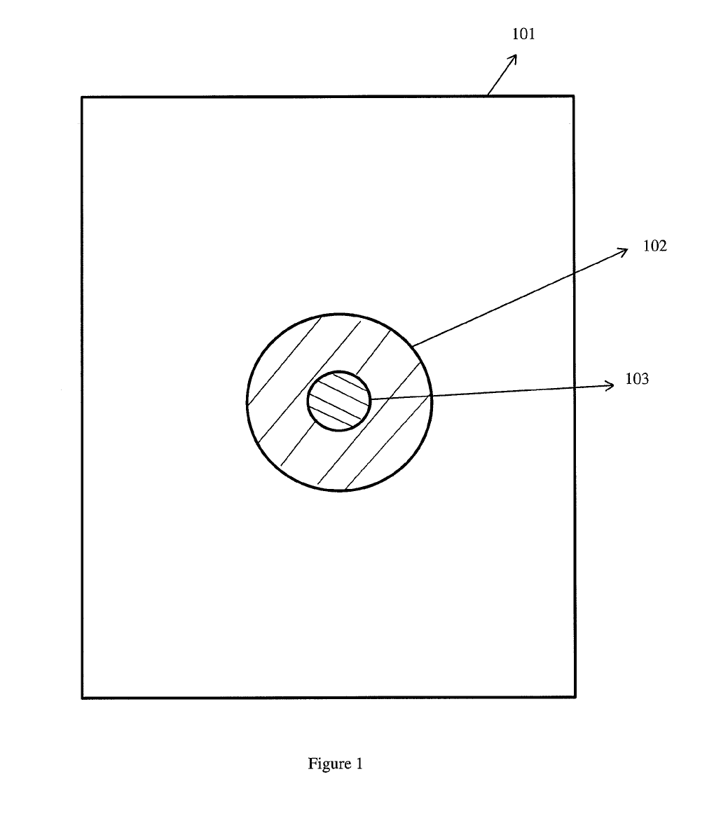

Referring to the drawings, FIG. 1 illustrates an end-face image of a fiber optic cable providing a cross-sectional view of the fiber core, according to an exemplary embodiment. End-face image 101 provides a cross-sectional view of the fiber optic cable 102 and the fiber core 103. Fiber optic cores are extremely small in diameter; the core of a typical single mode fiber is about 9 microns. To put this into proportion a human hair can range from 50 microns to 180 microns. Because of their small diameter fiber optic cores can easily become dirty or damaged, hence visual pass/fail analysis of the core is required before maintenance or installation. In many cases manual pass/fail analysis can become tedious and automated analysis is preferred. Automated pass/fail analysis is not possible until the type of the fiber, single-mode or multi-mode, within a given image is known. Current approaches require the user to select the fiber type prior to analysis or they will produce results assuming both modes and require the user to select which results apply.

Images of fiber optic end faces have several properties that may be used in determining the type of the fiber optic core.

First, multi-mode and single-mode cores have significantly different sizes under magnification. Multi-mode cores run the range between 50 microns and up in diameter, with 50 and 62.5 micron diameters being the most common. Single-mode cores are approximately 9 microns in diameter.

Second, ambient light that enters the fiber through the cable is clearly visible in the fiber core, making it easily identifiable in many cases.

Third, multi-mode and single-mode cores produce different gradients that can be identified by looking at the raw intensity data.

Although three properties are described above which may be used in determining the type of fiber, the number of properties that may be used is not limited thereto. Numerous other properties may be used to determine the type of fiber optic core 103 using the fiber optic end-face image 101. Furthermore, given these properties and the nature of the problem, artificial intelligence techniques, specifically supervised learning, can be used to determine the properties of the fiber optic core 103, thereby determining if the core 103 belongs to a multimode or single-mode fiber.

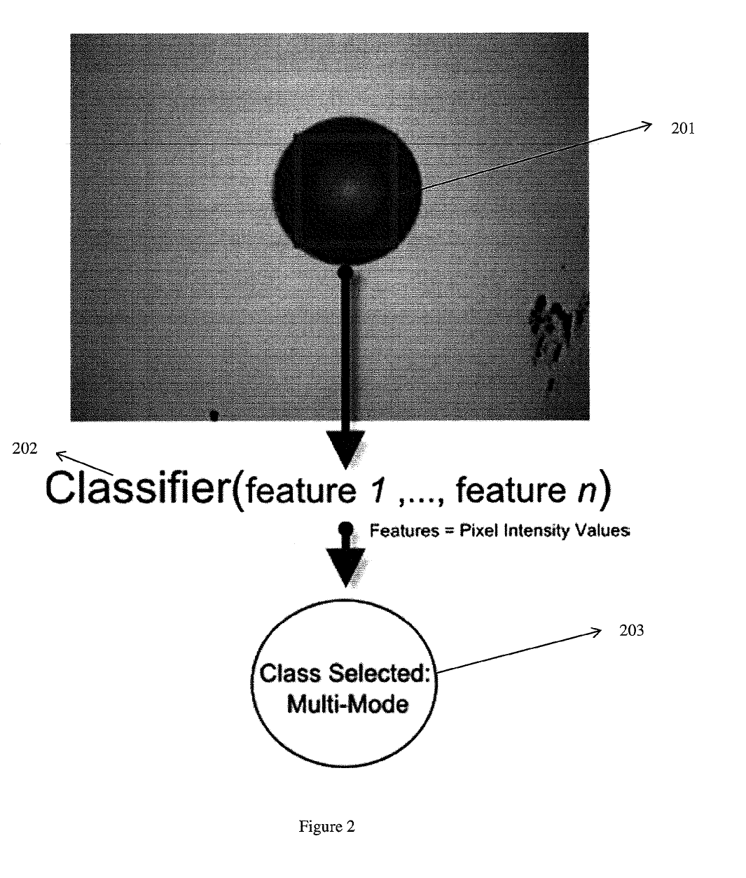

FIG. 2 illustrates an end-face image of a fiber optic cable providing a cross-sectional view of the fiber core along with a selected region around the fiber core used by a classifier to classify the type of fiber, according to an exemplary embodiment. A region around the core 201 is selected and the pixels in the selected region are passed into a classifier 202. The classifier then uses a feature of the selected region (for example Pixel Intensity values) whose pixels are received by the classifier to determine 203 if the region contains a single-mode or multi-mode core.

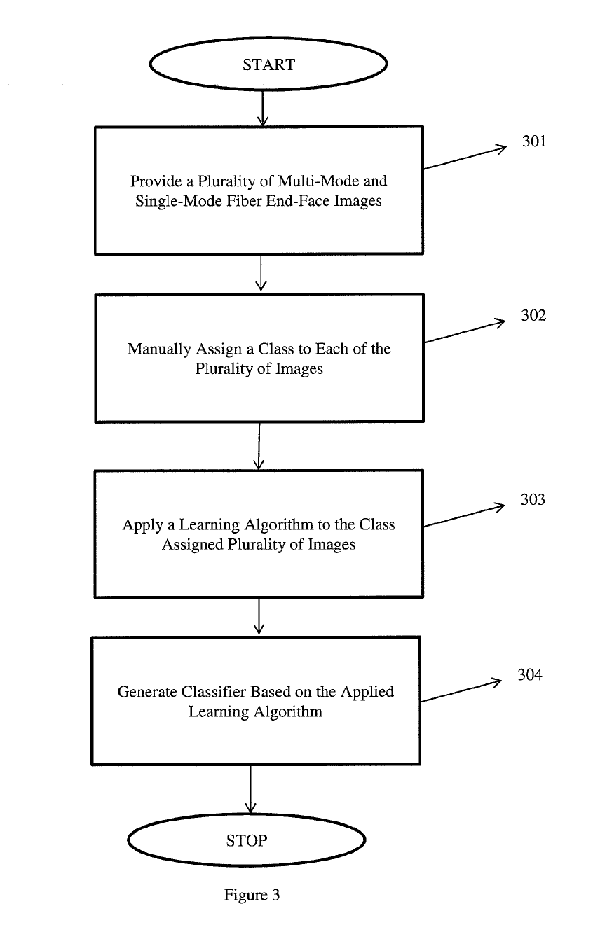

The process of generating a classifier and the functioning of the classifier will now be described in detail with reference to FIGS. 3, 4, and 5.

FIG. 3 is a flowchart describing the generation of a classifier, according to an exemplary embodiment.

A classifier is a function that is used for pattern matching. Classifiers come in many different forms and types. In order to detect the type of a fiber optic core a number of Artificial Neural Networks (ANNs) are evaluated. An artificial neural network (ANN) is a computational model that mimics a biological nervous system. It is commonly used in the field of computer science to enable machine learning and pattern recognition. In the general case an ANN is a set of interconnected functions known as neurons (analogous to neurons in a brain) used to map numerical inputs to numerical output. Inputs are known as features and are the data that contains the pattern. Outputs are known as classes and are the labels for the pattern.

Raw intensity values may be used as the features or parameters to the classification function, according to an exemplary embodiment. To create classifiers, a number of supervised learning techniques may be used. Each technique requires training examples. To create a training example, several hundred images of both multi-mode and single-mode fiber images are taken and a class is manually assigned to each of them, according to an exemplary embodiment. Numerous supervised learning algorithms may be used on the class assigned images to generate the classifiers.

As shown in the flowchart of FIG. 3, a plurality of multi-mode and single-mode fiber end-face images are provided in step 301. In step 302, each of the plurality of images is manually assigned a class, thereby forming a database for a classifier according to an exemplary embodiment. Following that a learning algorithm is applied on the class assigned images in step 303. One of ordinary skill in the art would understand that numerous different types of learning algorithms may be used in step 303. Lastly, based on the applied learning algorithm on the images, a classifier is generated in step 304.

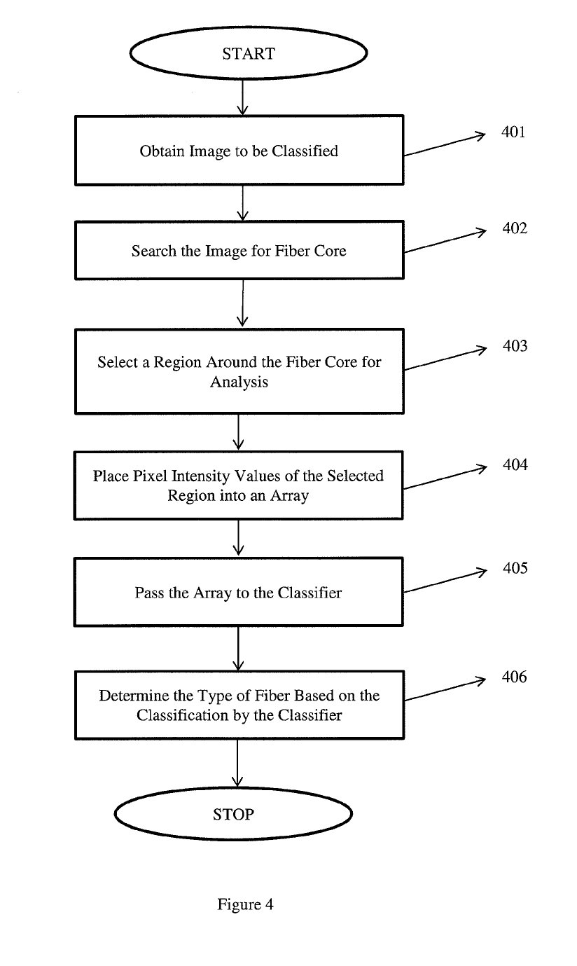

FIG. 4 is a flowchart describing the process of determining a fiber type, according to an exemplary embodiment.

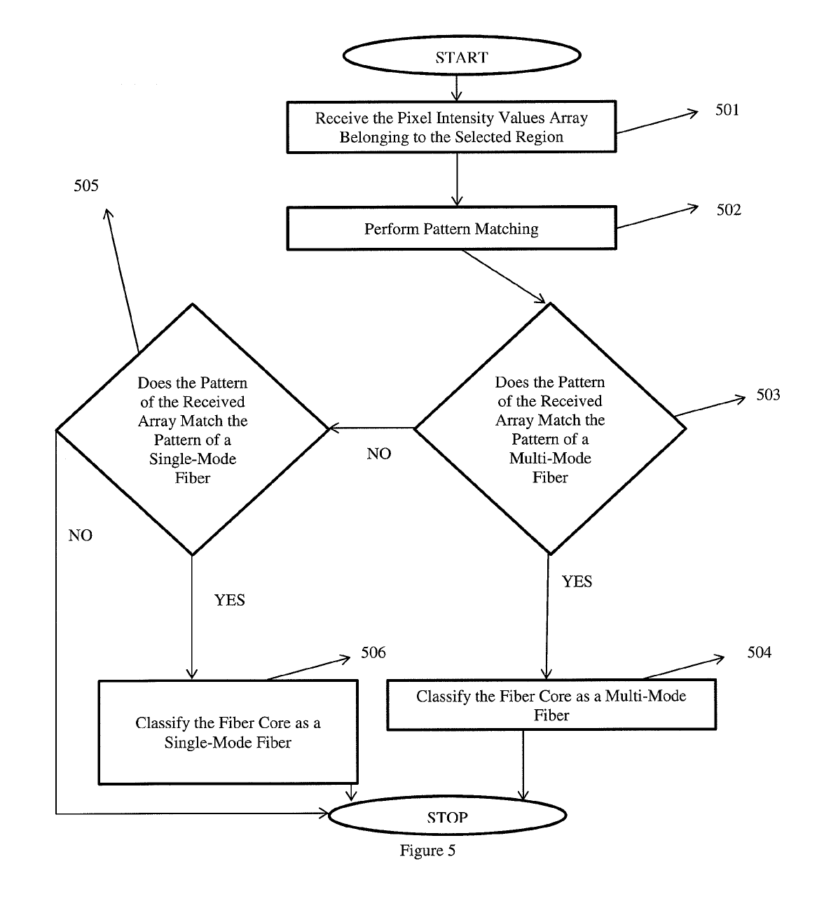

First, the algorithm is provided with an image to classify 401. The algorithm searches the image for the center/core of the fiber using basic machine vision techniques 402. Once the center/core has been found, a region around the center is cut out 403 and the pixel intensity values are placed into an array 404. This array is then passed to the classifier which classifies the fiber core based on passed array 405. The algorithm determines the type of the fiber based on the classification of the fiber core by the classifier 406. The description of FIG. 5 below will describe the functioning of the classifier in detail, according to an exemplary embodiment.

FIG. 5 is a flowchart describing the functionality of a classifier in classifying the fiber core based on the end-face image of the fiber optic cable, according to an exemplary embodiment.

In step 501, the classifier receives the pixel intensity values array belonging to the region around the fiber core selected by the algorithm. The classifier then performs pattern matching on the received pixel intensity values array in step 502. Numerous properties may be used in the pattern matching process to determine the type of fiber optic core using the fiber optic end-face image. In step 503, it is determined whether the pattern of the received pixel intensity values array matches the pattern of a multi-mode fiber. If the pattern of the received pixel intensity values array matches the pattern of a multi-mode fiber, the classifier classifies the fiber core, to which the receiver pixel intensity array belongs, as a multi-mode fiber 504. If the pattern of the received pixel intensity values array does not match the pattern of a multi-mode fiber, the classifier compares the pattern of the received pixel intensity values array and the pattern of a single-mode fiber 505. If the pattern of the received pixel intensity values array matches the pattern of a single-mode fiber, the classifier classifies the fiber core, to which the receiver pixel intensity array belongs, as a single-mode fiber 506. If the pattern of the received pixel intensity values array does note the pattern of a single-mode fiber, the classifier stops the process or may return a nil value to the algorithm, according to an exemplary embodiment.

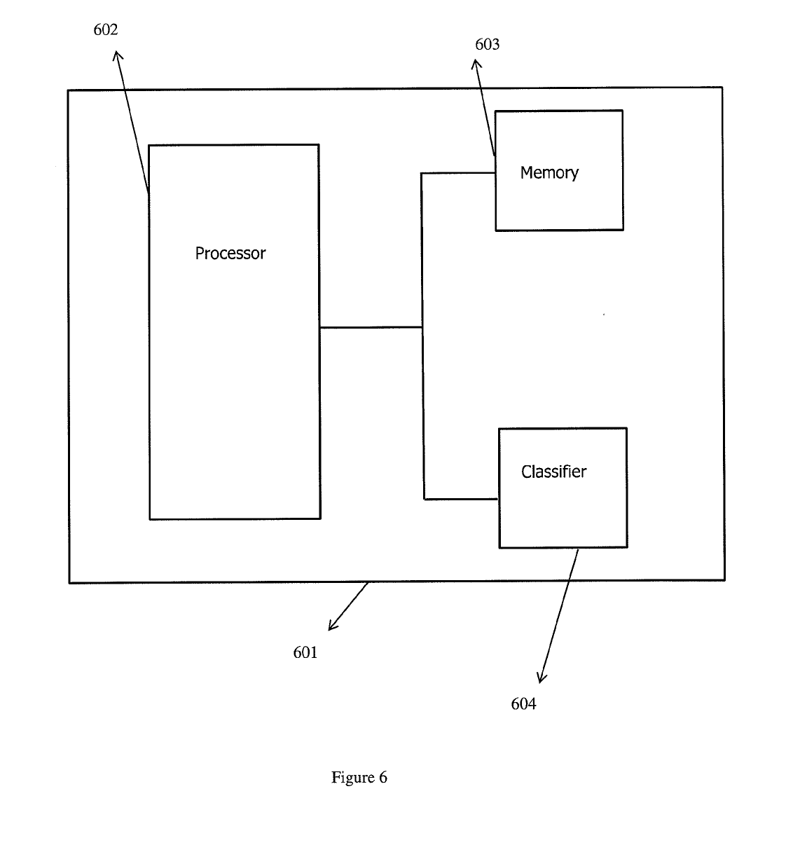

FIG. 6 illustrates a functional block diagram of an embodiment of an apparatus which determines the type of fiber in a fiber optic end-face image, according to an exemplary embodiment. The fiber type determining apparatus 601 includes a memory 603, a processor 602, and a classifier 604, according to an exemplary embodiment. An example of a processor is an ARM Xscale 806 Mhz processor. An example of a memory is an 8 Gbit NAND flash memory. The classifier 604 may be stored in the memory 603 according to another exemplary embodiment. The memory may store a program code/operating software which in-turn instructs the processor 602 to determine the type of fiber in a fiber optic end face image using a classifier 604 as described in the flowcharts of FIGS. 3, 4, and 5 above. The program code/operating software can also be stored on a non-transitory computer readable medium.

Having an accurate and reliable way of determining the type of a fiber core autonomously may provide numerous benefits and numerous useful applications. First, automatic pass/fail analysis can proceed completely without the need for user intervention, thereby removing human subjectivity from the selection of the type of fiber. Second, fewer mistakes may be made in the field since the user would not be required to select the fiber type or decided which set of results applies to a given fiber. Third, it may reduce the amount of time needed to run automatic pass/fail analysis and hence may save time and money since both fiber types need not be considered. Fourth, automatic detecting mode may allow the application to auto select the correct pass/fail specification and zone sizes.

Although four main benefits of automatic detection of the type of fiber are listed above, the benefits are not limited thereto.

As mentioned above, the embodiments described above are merely exemplary and the general inventive concept should not be limited thereto. While this specification contains many features, the features should not be construed as limitations on the scope of the disclosure or the appended claims. Certain features described in the context of separate embodiments can also be implemented in combination. Conversely, various features described in the context of a single embodiment can also be implemented in multiple embodiments separately or in any suitable sub-combination.

1-21. (canceled)

22. A method, performed by an apparatus including at least one processor, of automatically determining a type of fiber in a fiber optic end-face image, the method comprising:
obtaining, using said at least one processor, the fiber optic end-face image;
searching, using said at least one processor, the fiber optic end-face image to find a fiber core;
selecting, using said at least one processor, a region in the fiber optic end-face image comprising the fiber core;
retrieving, using said at least one processor, pixel intensity values of selected region; placing, using said at least one processor, the retrieved pixel intensity values in an array; passing, using said at least one processor, the array to a classifier; and
determining, using said at least one processor, a type of fiber based on a classification made by the classifier.

23. The method of claim 22, wherein the classifier performs pattern matching on the array to classify the fiber core.

24. The method of claim 22, wherein the classification made by the classifier is one of multi-mode fiber or single-mode fiber.

25. The method of claim 22, wherein the determining the type of fiber comprises one of determining that the fiber is a multi-mode fiber or determining that the fiber is a single-mode fiber.

26. The method of claim 22, wherein the classifier uses at least one of a plurality of properties of the fiber optic end-face image to classify the fiber core.

27. A method, performed by an apparatus including at least one processor, of classifying a fiber core, the method comprising:
receiving, using said at least one processor, an array of pixel intensity values corresponding to a selected region of a fiber optic end-face image;
performing, using said at least one processor, pattern matching on the received array; and classifying, using said at least one processor, the fiber core corresponding to the fiber optic end-face image based on the pattern matching.

28. The method of claim 27, wherein performing the pattern matching comprises comparing the pattern of the received array with the pattern of multi-mode fiber and single mode fiber.

29. The method of claim 27, wherein the selected region comprises the fiber core.

30. The method of claim 27, wherein the classifying the fiber core comprises one of classifying the fiber core as a multi-mode fiber or classifying the fiber core as a single-mode fiber.

31. A method, performed by an apparatus including at least one processor, of generating a classifier which classifies a fiber core using a fiber optic end-face image, the method comprising:
obtaining, using said at least one processor, a plurality fiber optic end-face images; manually assigning, using said at least one processor, a class to each of the plurality of fiber optic end-face images;
applying, using said at least one processor, a learning algorithm to the plurality of class assigned fiber optic end-face images; and
generating, using said at least one processor, a classifier based on the applied learning algorithm.

32. The method of claim 31, wherein the learning algorithm is a supervised learning algorithm.

33. The method of claim 31, wherein manually assigning a class comprises one of manually assigning a multi-mode fiber class or manually assigning a single-mode fiber class.

34. An apparatus for automatically determining a type of fiber in a fiber optic endface image, the apparatus comprising:
at least one memory operable to store program code;
at least one processor operable to read the program code and operate as instructed by the program code, the program code including:
obtaining code configured to cause the at least one processor to obtain a the fiber optic end-face image;
searching code configured to cause the at least one processor to search the fiber optic end-face image to find a fiber core;
selecting code configured to cause the at least one processor to select a region in the fiber optic end-face image comprising the fiber core;
retrieving code configured to cause the at least one processor to retrieve pixel intensity values of selected region;
placing code configured to cause the at least one processor to place the retrieved pixel intensity values in an array;
passing code configured to cause the at least one processor to pass the array to a classifier; and
determining code configured to cause the at least one processor to determine a type of fiber based on a classification made by the classifier.

35. The apparatus of claim 34, wherein the classifier performs pattern matching on the array to classify the fiber core.

36. The apparatus of claim 34, wherein the classification made by the classifier is one of multi-mode fiber or single-mode fiber.

37. The apparatus of claim 34, wherein the determining code is configured to cause the at least one processor to one of determine that the fiber is a multi-mode fiber or determine that the fiber is a single-mode fiber.

38. The apparatus of claim 34, wherein the classifier uses at least one of a plurality of properties of the fiber optic end-face image to classify the fiber core.

39. A non-transitory computer readable recording medium storing a program used in an apparatus, including at least one processor, for automatically determining a type of fiber in a fiber optic end-face image, the program causing said at least one processor to:
obtain a the fiber optic end-face image;
search the fiber optic end-face image to find a fiber core;
select a region in the fiber optic end-face image comprising the fiber core; retrieve pixel intensity values of selected region;
place the retrieved pixel intensity values in an array;
pass the array to a classifier; and
determine a type of fiber based on a classification made by the classifier.

40. The non-transitory computer readable recording medium of claim 39, wherein the classifier uses at least one of a plurality of properties of the fiber optic end-face image to classify the fiber core.

41. The non-transitory computer readable recording medium of claim 39, wherein the program further causes said at least one processor to one of determine that the fiber is a multi-mode fiber or determine that the fiber is a single-mode fiber.
